(19) United States
(12) Patent Application Publication
(10) Pub. No.: US 2022/0251412 A1
(43) Pub. Date: Aug. 11, 2022

(54) Impregnating Formulation, Insulation Material, Method for Producing an Insulation Material, and Electrical Machine with an Insulation Material

(71) Applicant: Siemens Aktiengesellschaft, München (DE)

(72) Inventors: Jürgen Huber, Erlangen (DE); Steffen Lang, Hallerndorf (DE); Niels Müller, Nürnberg (DE); Michael Nagel, Gremsdorf (DE); Matthias Übler, Ursensollen (DE)

(73) Assignee: Siemens Aktiengesellschaft, München (DE)

(21) Appl. No.: 17/622,737

(22) PCT Filed: Jun. 2, 2020
(86) PCT No.: PCT/EP2020/065211

§ 371 Date: Dec. 24, 2021

(30) Foreign Application Priority Data
Jun. 27, 2019 (DE) 10 2019 209 346.9

(51) Int. Cl. C09D 163/00; C08G 59/30; C08G 59/24; C08G 59/22; C08G 59/42; C08G 59/68; C08J 5/24; C09J 7/30

(52) U.S. Cl. CPC C09D 163/00; C08G 59/306; C08G 59/245; C08G 59/226; C08G 59/4238; C09J 2463/00; C08J 5/249; C09J 7/30; C08J 2363/02; C09J 2203/326; C08G 59/686

(57) ABSTRACT

Various embodiments include an impregnation formulation for a wrapping tape insulation of an electrical machine. The formulation comprises: a resin formulation with an epoxy base resin and a first component; and a hardener formulation with a hardener. The resin formulation reacts when combined with the hardener formulation to produce an insulation material. The first component includes a saturated and/or unsaturated epoxycycloalkyl group. A glass transition temperature of the insulation material is elevated compared to an impregnation formulation without the first component.

### CROSS-REFERENCE TO RELATED APPLICATIONS

This application is a U.S. National Stage Application of International Application No. PCT/EP2020/065211 filed Jun. 2, 2020, which designates the United States of America, and claims priority to DE Application No. 10 2019 209 346.9 filed Jun. 27, 2019, the contents of which are hereby incorporated by reference in their entirety.

### TECHNICAL FIELD

The present disclosure relates to electrical machines. Various embodiments of the teachings herein include impregnation formulations and insulation materials for a wrapping tape insulation of an electrical machine, processes for producing an insulation material, and/or electrical machines comprising such an insulation material.

### BACKGROUND

Electrical machines, for example motors and generators, in the multitude of the longitudinal grooves of the laminate stack, have special kinds of coil windings or conductor bars generally consisting of copper or another material of high conductivity. In the case of an electric motor, by supplying current in a time-selective manner, a magnetic field propagating in all directions is generated, this drives the freely rotating rotor suspended in the stator cavity, and the rotor reacts to the induced magnetic field in the form of forced rotation, for example owing to a multitude of applied permanent magnets, and hence converts electrical energy to kinetic energy.

In electrical terms, the laminate stack here is at ground potential, but the coils are at high kilovolt potential. The coils fitted into the stator grooves must accordingly be electrically insulated with respect to ground potential. For this purpose, each coil is wrapped and insulated, repeatedly and with defined overlap, with a special mica-based tape (called mica tape). In general, mica is used since, being a particulate inorganic barrier material, especially in platelet form, it is capable of retarding electrical erosion under electrical partial discharges effectively and for a long period, preferably over the entire lifetime of the machine, or of the generator, and has good chemical and thermal stability.

Mica tapes consist of mica paper and one or more carriers, for example fabrics, film(s), bonded to one another via a tape adhesive. Mica tapes are necessary since mica paper alone does not typically have the mechanical strength needed for an insulation process. According to the particular use, further additives may be added to the tape adhesive, for example accelerator substances, which have an initiating effect on the curing of an applied impregnating agent to give a solid insulation material. Since the distance from current-carrying isolated coil to the laminate stack is generally kept as small as possible, field strengths of several kV/mm there are not unusual. There is corresponding stress on the insulation material.

Impregnation formulations that are now in use include those comprising, as resin formulation, one or more epoxy-based resins and one or more covalently copolymerizable polysiloxanes, said resin formulation reacting with a hardener formulation to give a polymer structure in the insulation material that degrades only very slowly, or virtually not at all, even under very significant electrical partial discharge stress. Use of polysiloxane-containing impregnation formulations accordingly makes it possible to produce insulation materials in electrical machines by established methods at standard processing temperatures, with the insulation materials having much better electrical properties compared to polysiloxane-free insulation materials.

With rising polysiloxane content in a modified epoxy resin mixture, however, there is a drop in the glass transition temperature or glass transition temperature range since organic polysiloxanes, on account of their chemical structure—similarly to typical flexibilizer additives—lead to decreasing glass transition temperatures in otherwise flexibilizer-free epoxy base resins. According to the uses, it is thus possible to increase erosion resistance against partial discharges via correspondingly high polysiloxane additive contents, but at the same time there is such a significant decrease in the glass transition temperature of the insulation material that even elevated operating temperatures of electrical machines endowed with such insulation materials are sufficient for brief or sustained exceedance of the glass transition temperature of the insulation, which leads to degradation of the insulation, to elevated electrical losses and to worsened mechanical properties and shortened lifetimes of the electrical machine.

### SUMMARY

The teachings of the present disclosure describe an impregnation formulation that permits the production of an insulation material that has improved electrical and mechanical stability even at relatively high operating temperatures of an assigned electrical machine. For example, some embodiments of the teachings herein include an impregnation formulation for a wrapping tape insulation of an electrical machine, comprising a resin formulation with at least one epoxy base resin and a hardener formulation with at least one hardener, wherein the resin formulation can react with the hardener formulation to give an insulation material (IM1-IM6), characterized in that the resin formulation, in addition to the epoxy base resin, comprises at least one component having at least one saturated and/or unsaturated epoxycycloalkyl group, by means of which a glass transition temperature of the insulation material (IM1-IM6) is elevated compared to an impregnation formulation without the component.

In some embodiments, the component comprises at least 2 and/or between 8 and 12 saturated and/or unsaturated epoxycycloalkyl groups.

In some embodiments, the at least one epoxycycloalkyl group is selected from the group comprising epoxy-C3-C8-cycloalkyl groups and/or wherein the at least one epoxycycloalkyl group is bonded to a structural element of the component via a spacer.

In some embodiments, the component comprises at least one polysilsesquioxane containing epoxycycloalkyl groups.

In some embodiments, the at least one polysilsesquioxane containing epoxycycloalkyl groups has a random structure, a ladder structure or a cage structure.

In some embodiments, the component comprises a cycloaliphatic epoxy resin, especially 3,4-epoxycyclohexylmethyl 3′,4′-epoxycyclohexanecarboxylate.

In some embodiments, the resin formulation additionally comprises at least one polysiloxane, especially a glycidyl ether-terminated poly(dialkylsiloxane) and/or a diglycidyl ether-terminated poly(phenylsiloxane).

In some embodiments, the epoxy base resin is selected from the group comprising phthalic anhydride derivative-containing epoxy resins and phthalic anhydride derivative-free epoxy resins, especially bisphenol A diglycidyl ether (BADGE), bisphenol F diglycidyl ether (BFDGE), epoxy novolak, epoxyphenol novolak, polyurethanes or any mixture thereof.

In some embodiments, the hardener formulation is selected from the group comprising cationic and anionic curing catalysts, amines, acid anhydrides, especially methylhexahydrophthalic anhydride, siloxane-based hardeners, oxirane group-containing hardeners, especially glycidyl ethers, superacids, epoxy-functionalized hardeners or any mixture thereof, and/or in that the hardener formulation comprises at least one accelerator substance, especially a tertiary amine and or an organic zinc salt.

In some embodiments, the resin formulation includes compounds that form a —CR₂— backbone in a proportion of at least 10% by weight, and/or wherein compounds that form a —SiR₂—O— backbone in a proportion of at least 5% by weight.

In some embodiments, a proportion of the at least one component in the resin formulation is at least 1% by weight and/or at most 95% by weight.

As another example, some embodiments include an insulation material (IM1-IM6) for a wrapping tape insulation of an electrical machine, obtainable and/or obtained from an impregnation formulation as described herein, wherein the insulation material (IM1-IM6) has a glass transition temperature of at least 90° C.

As another example, some embodiments include a method of producing an insulation material (IM1-IM6), especially for a wrapping tape insulation of an electrical machine, in which an impregnation formulation as described herein is provided and the resin formulation and the hardener formulation in the impregnation formulation are reacted with one another and cured to give the insulation material (IM1-IM6), wherein the insulation material (IM1-IM6) has a glass transition temperature of at least 90° C.

In some embodiments, at least one element from the group of support materials, barrier materials and tape adhesives is impregnated with the impregnation formulation, and the insulation material (IM1-IM6) is produced by a vacuum pressure impregnation process.

As another example, some embodiments include an electrical machine, especially mid- and/or high-voltage machine, comprising an insulation material (IM1-IM6) formed and/or obtainable and/or obtained by means of an impregnation formulation as described herein.

### BRIEF DESCRIPTION OF THE DRAWINGS

The figures show:

FIG. 1 a comparison of a partial discharge or erosion characteristic of an insulation material incorporating teachings of the present disclosure compared to two prior art insulation materials;

FIG. 2 dynamic differential calorimetry measurements on an insulation material incorporating teachings of the present disclosure compared to multiple prior art insulation materials;

FIG. 3 a diagram showing electrical loss factors of insulation materials incorporating teachings of the present disclosure compared to multiple prior art insulation materials;

FIG. 4 a diagram showing relative permittivities of insulation materials incorporating teachings of the present disclosure compared to multiple prior art insulation materials; and

FIG. 5 dynamic differential calorimetry measurements on different insulation materials incorporating teachings of the present disclosure compared to a prior art insulation material.

### DETAILED DESCRIPTION

Further features of the teachings herein are apparent from the claims, the figures, and the description of figures. The features and combinations of features specified above in the description, and the features and combinations of features that are mentioned hereinafter in the description of figures and/or shown in the figures alone are usable not just in the particular combination specified but also in other combinations without leaving the scope of the disclosure. The disclosure is thus also considered to encompass and disclose executions of the teachings herein that are not explicitly shown and elucidated in the figures but are apparent and can be created via separated combinations of features from the executions elucidated. Also considered to be disclosed are executions and combinations of features which are executions and combinations of features, especially by virtue of the above-detailed executions, that go beyond or differ from the combinations of features detailed in the dependency references of the claims.

Some embodiments of the teachings herein include an impregnation formulation for a wrapping tape insulation of an electrical machine, comprising a resin formulation with at least one epoxy base resin and a hardener formulation with at least one hardener, wherein the resin formulation can react with the hardener formulation to give an insulation material. As taught herein, improved electrical and mechanical stability is enabled in that the resin formulation, in addition to the epoxy base resin, comprises at least one component having at least one saturated and/or unsaturated epoxycycloalkyl group, by means of which a glass transition temperature of the insulation material is elevated compared to an impregnation formulation without the component. In some embodiments, the resin formulation contains at least two constituents: an epoxy base resin and a component having one or more epoxycycloalkyl groups, where each of the epoxycyclo-alkyl groups may be saturated or mono- or polyunsaturated. Unsaturated epoxycycloalkyl groups may also be referred to as epoxycycloalkenyl groups.

The cycloaliphatic epoxy functionality/functionalities of the component is/are very sterically demanding and has/have a high space demand on account of the nonplanar cycloaliphatic ring structure. Therefore, the incorporation of this/these structure(s) into the polymeric network of the cured insulation material, compared to an impregnation formulation that does not contain the at least one component but is otherwise of identical composition, leads to higher glass transition temperatures with simultaneously elevated electrical stability of the cured insulation material.

The glass transition generally takes place not at a sharp temperature value but within a glass transition temperature range. The glass transition temperature used in such a case is the average temperature value of the glass transition temperature range. The molar stoichiometric ratio of resin formulation to hardener formulation may be adjusted as required, with typical use of a value of about 1:0.9 to about 1:1.

In some embodiments, the component comprises at least 2 and/or between 8 and 12 saturated and/or unsaturated epoxycycloalkyl groups. In other words, the component has multiple saturated and/or unsaturated epoxycycloalkyl groups, namely, for example, 2, 3, 4, 5, 6, 7, 8, 9, 10, 11, 12 or more. As a result, it is possible to use the component as a multifunctional crosslinker with adjustable space requirement, by means of which the glass transition temperature of the cured insulation material is adjustable in a particularly precise manner.

In some embodiments, the at least one epoxycycloalkyl group is bonded to a structural element of the component via a spacer. The spacer may, for example, be a C₁-C₁₂-alkyl radical and may generally be attached to any suitable position in the cycloalkyl group. This likewise enables particularly precise adjustment of the glass transition temperature and, in the individual case, facilitates the arrangement of multiple epoxycycloalkyl groups on the structural element of the component.

In some embodiments, the at least one epoxycycloalkyl group is selected from a group comprising epoxy-C3-C8-cycloalkyl groups. In other words, the at least one epoxycycloalkyl group may be an epoxycyclopropyl, epoxycyclobutyl, epoxycyclopentyl, epoxycyclohexyl, epoxycyclo-heptyl, or epoxycyclooctyl group. In this way too, the space demand of the component and hence the glass transition temperature of the cured insulation material may be adjusted in a particularly precise manner.

In some embodiments, the component comprises at least one polysilsesquioxane containing epoxycycloalkyl groups. Polysilsesquioxanes are silicon resins that can be synthesized using trifunctional organosilane compounds and are an organic inorganic hybrid material that binds the inorganic properties of the siloxane bond (Si—O—Si) that forms the main chain and the organic properties of the organic functional group that forms the side chain(s).

This molecular “sand”, which is liquid at room temperature, typically has particle diameters of ≤1 nm, can generally be modified with one or more epoxycycloalkyl functionalities, with every epoxycycloalkyl group optionally being bondable via a spacer, for instance a methyl, ethyl, propyl group etc., to a silicon atom as structural element of the polysilsesquioxane. As a result, such polysilsesquioxane derivatives firstly have good solubility in epoxy resins; secondly, their UV stability and hydrophobicity may be increased.

The cycloaliphatic epoxy functionality/functionalities of these hybrid molecules can copolymerize, for example, with an anhydride-containing base epoxy resin and are thus incorporated completely and in a highly dispersed manner in the resulting insulation material. The cycloaliphatic epoxy functionality/functionalities has/have the high steric demands already mentioned on account of the nonaromatic ring structure(s) and, when the component is incorporated into the polymeric network, lead to higher glass transition temperatures.

Since the backbone of these polysilsesquioxane derivatives that serve as additives consists of a (poly)oligosiloxane—i.e. organically modified silicon which, for example, according to the formula (epoxycyclohexyl-ethyl)₈₋₁₂ (SiO_{1.5})₈₋₁₂, has already been oxidized 1.5 times—the step to the fully oxidized and virtually organically embedded silicon dioxide is reached very rapidly as a result of partial discharge bombardment in the operation of an assigned electrical machine, such that these polysilsesquioxane derivatives in the insulation material of the invention are converted in situ under electrical stress to a highly active antierosion additive. The polysilsesquioxane derivatives mentioned additionally have further advantageous properties such as transparency, heat resistance, hardness, electrical durability, dimensional stability (low thermal expansion) and flame retardant characteristics. As well as one or more cycloaliphatic epoxy functionality/functionalities, it is possible in principle for one or more different functional groups to be provided, via which further properties such as compatibility with the epoxy base resin and/or a hardener formulation, dispersion stability, storage stability, break factor and reactivity, can be adjusted.

Further advantages arise by virtue of the at least one epoxycycloalkyl group-containing polysilsesquioxane having a random structure, a ladder structure or a cage structure. It is possible in this way to specifically influence the resulting glass transition temperature of the insulation material. For example, the polysilsesquioxane containing epoxycycloalkyl groups may have a cage structure having 6, 8, 10 or 12 Si vertices.

In some embodiments, the component comprises or is a cycloaliphatic epoxy resin, especially 3,4-epoxycyclohexylmethyl 3′,4′-epoxycyclohexane-carboxylate. This too may be an advantageous glass modifier by means of which the glass transition temperature of the cured insulation material can advantageously be increased.

In some embodiments, the resin formulation additionally comprises at least one polysiloxane, especially a diglycidyl ether-terminated poly(dialkylsiloxane) and/or a diglycidyl ether-terminated poly(phenylsiloxane). Polysiloxanes, like polysilsesquioxanes, may form a —SiR₂—O— backbone in the cured insulation material. “R” here represents all kinds of organic radicals suitable for curing or crosslinking to give an insulation material.

In some embodiments, the R represents -aryl, -alkyl, -heterocycles, nitrogen-, oxygen- and/or sulfur-substituted aryls and/or alkyls. In particular, R may be chosen so as to be the same or different and may generally represent the following groups: -alkyl, for example -methyl, -propyl, -isopropyl, -butyl, -isobutyl, -tert-butyl, -pentyl, -isopentyl, -cyclopentyl and all other analogs up to dodecyl, i.e. the homolog having 12 carbon atoms;
aryl, for example: benzyl-, benzoyl-, biphenyl-, toluyl-, xylenes etc., especially, for example, all aryl radicals conforming to Hückel's definition of aromaticity,
heterocycles: especially sulfur-containing heterocycles such as thiophene, tetrahydrothiophene, 1,4-thioxane and homologs and/or derivatives thereof,
oxygen-containing heterocycles, for example dioxanes,
nitrogen-containing heterocycles, for example —CN, —CNO, —CNS, —N₃ (azide) etc.,
sulfur-substituted aryls and/or alkyls: e.g. thiophene, but also thiols.

In some embodiments, the epoxy base resin is selected from a group comprising phthalic anhydride derivative-containing epoxy resins and phthalic anhydride derivative-free epoxy resins, especially bisphenol A diglycidyl ether (BADGE), bisphenol F diglycidyl ether (BFDGE), epoxy novolak, epoxyphenol novolak, epoxypolyurethanes or any mixture thereof. For example, the epoxy base resin may be undistilled and/or distilled, optionally reactively diluted bisphenol A diglycidyl ether, undistilled and/or distilled, optionally reactively diluted bisphenol F diglycidyl ether, hydrogenated bisphenol A diglycidyl ether and/or hydrogenated bisphenol F diglycidyl ether, pure and/or solvent-diluted epoxy novolak and/or epoxyphenol novolak, cycloaliphatic epoxy resins such as 3,4-epoxycyclohexylmethyl 3,4-epoxycyclohexyl-carboxylate, e.g. CY179, ERL-4221; Celloxide 2021P, bis(3,4-epoxycyclohexylmethyl) adipate, e.g. ERL-4299; Celloxide 2081, vinylcyclohexene diepoxide, e.g. ERL-4206; Celloxide 2000, 2-(3,4-epoxycyclohexyl-5,5-spiro-3,4-epoxy)cyclohexane-meta-dioxane, e.g. ERL-4234; diglycidyl hexahydrophthalate, e.g. CY184, EPalloy 5200; tetrahydrophthalic acid diglycidyl ether e.g. CY192; glycidated amino resins (N,N-diglycidyl-para-glycidyloxyaniline, e.g. MY0500, MY0510, N,N-diglycidyl-meta-glycidyloxyaniline, e.g. MY0600, MY0610, N,N,N′,N′-tetraglycidyl-4,4′-methylenedianiline e.g. MY720, MY721, MY725, and any mixtures of the aforementioned compounds.

In some embodiments, the hardener formulation is selected from the group comprising cationic and anionic curing catalysts, amines, acid anhydrides, especially methylhexahydrophthalic anhydride, siloxane-based hardeners, oxirane group-containing hardeners, especially glycidyl ethers, superacids, epoxy-functionalized hardeners or any mixture thereof, and/or in that the hardener formulation comprises at least one accelerator substance, especially a tertiary amine and or an organic zinc salt. For example, the hardener formulation may comprise organic salts, such as organic ammonium, sulfonium, iodonium, phosphonium and/or imidazolium salts, and amines, such as tertiary amines, pyrazoles and/or imidazole compounds. Examples here include 4,5-dihydroxymethyl-2-phenylimidazole and/or 2-phenyl-4-methyl-5-hydroxymethyl-imidazole.

In some embodiments, the resin formulation includes compounds that form a —CR₂— backbone in a proportion of at least 10% by weight, i.e., for example, of 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98% or 99%. Percentages in the context of the present disclosure should fundamentally be regarded as percentages by weight unless stated otherwise.

In some embodiments, compounds that form a —SiR₂—O— backbone where R is independently selected from the aforementioned organic radicals are in a proportion of at least 5% by weight, i.e., for example, of 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98% or 99%. It will be apparent that the molar proportions of all compounds of the resin formulation always and exclusively add up to 100% by weight. The same is of course also applicable to the hardener formulation. In this way, it is possible to optimize the chemical, mechanical, and thermal properties of the resulting insulation material to the respective end use.

In some embodiments, advantages arise by virtue of a proportion of the at least one component in the resin formulation being at least 1% by weight, i.e., for example, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98% or 99%, and/or at most 95%. In this way, as well as the glass transition temperature, it is also possible to optimize the chemical, mechanical, and thermal properties of the resulting insulation material to the respective end use.

In some embodiments, there is an insulation material for wrapping tape insulation of an electrical machine, wherein the insulation material is obtainable and/or has been obtained in accordance with the invention from an impregnation formulation as described herein, wherein the insulation material has a glass transition temperature of at least 90° C. In this way, the insulation material, on account of the component having at least one saturated and/or unsaturated epoxycycloalkyl group which has been incorporated into the polymer skeleton, has a higher glass transition temperature compared to an insulation material that has otherwise been produced in the same way but without the component, and hence improved electrical and mechanical stability even at higher operating temperatures of an assigned electrical machine.

A glass transition temperature of at least 90° C. is understood to mean, for example, glass transition temperatures of 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., 131° C., 132° C., 133° C., 134° C., 135° C., 136° C., 137° C., 138° C., 139° C., 140° C., 141° C., 142° C., 143° C., 144° C., 145° C., 146° C., 147° C., 148° C., 149° C., 150° C., 151° C., 152° C., 153° C., 154° C., 155° C., 156° C., 157° C., 158° C., 159° C., 160° C., 161° C., 162° C., 163° C., 164° C., 165° C., 166° C., 167° C., 168° C., 169° C., 170° C., 171° C., 172° C., 173° C., 174° C., 175° C., 176° C., 177° C., 178° C., 179° C., 180° C., 181° C., 182° C., 183° C., 184° C., 185° C., 186° C., 187° C., 188° C., 189° C., 190° C. or more.

In some embodiments, there is a method of producing an insulation material for a wrapping tape insulation of an electrical machine, in which an impregnation formulation as described herein is provided, and the resin formulation and hardener formulation in the impregnation formulation are reacted with one another and cured to give the insulation material, wherein the insulation material has a glass transition temperature of at least 90° C. In this way, it is possible to ensure a relatively high glass transition temperature of the insulation material and hence also an improved electrical and mechanical stability at relatively high operating temperatures of the electrical machine. Further features and further advantages can be inferred from the descriptions of the various embodiments.

In some embodiments, at least one element from the group of carrier materials, barrier materials, and tape adhesive is impregnated with the impregnation formulation, and the insulation material is produced by a vacuum pressure impregnation method. The impregnation fills the cavities present between the individual particles and/or tape folds in the carrier material, for example mica paper, with the insulation formulation. The composite composed of impregnation formulation and carrier material is hardened and forms the solid insulation material that then gives the mechanical strength of the insulation system. The electrical strength results from the multitude of solid-solid interfaces. The vacuum pressure impregnation method (VPI process) also makes it possible to fill ultrasmall cavities in the insulation of the insulation formulation, which minimizes the number of internal gas-solid interfaces and prevents partial discharges during the later operation of the electrical machine.

In some embodiments, there is an electrical machine, e.g., a mid- and/or high-voltage machine, which comprises an insulation material formed and/or obtainable and/or obtained by an impregnation formulation and/or by a method as described herein.

The resulting features and advantages thereof can be inferred from the descriptions of the corresponding aspects.

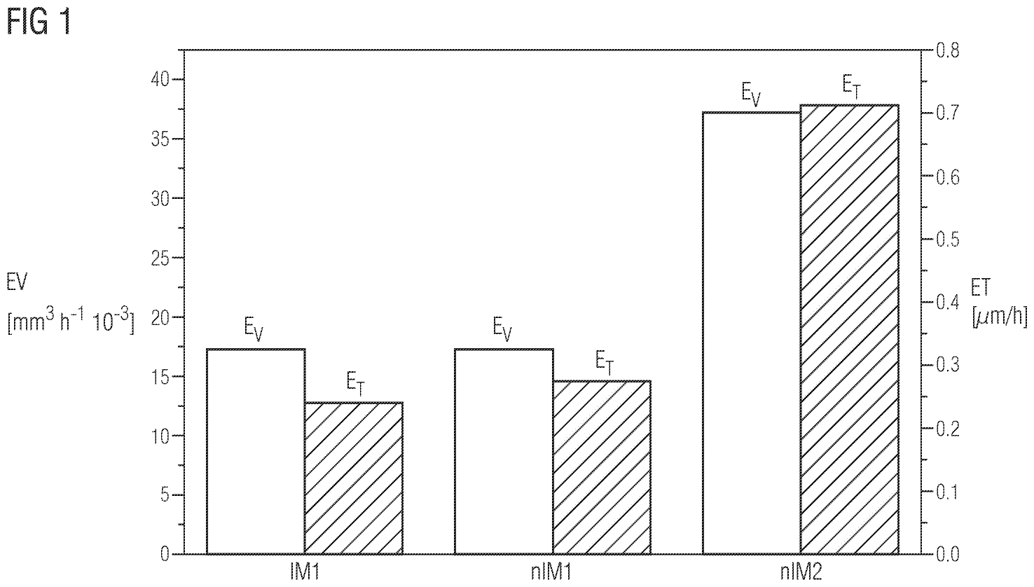

FIG. 1 shows a comparison of a partial discharge or erosion characteristic of an insulation material IM1 compared to two insulation materials nIM1, nIM2. Plotted on the y axis on the left-hand scale is the eroded volume E_{V} [mm³ h⁻¹ 10⁻³] and on the right-hand scale the erosion depth E_{T} [μm/h]. The insulation material nIM2 is produced from a conventional Micalastic™ impregnation formulation containing a roughly equal-mass or approximately stoichiometric mixture of distilled bisphenol A diglycidyl ether as epoxy base resin of the resin formulation and methylhexahydrophthalic anhydride as hardener formulation, which is cured thermally to give the insulation material by means of fundamentally optional accelerator substances based on tertiary amines and/or organic zinc salts in a vacuum pressure impregnation process as stator winding of an electrical machine (not shown). The insulation material nIM1 is produced from an impregnation formulation in which, by comparison to the Micalastic™ impregnation formulation, 10% by weight of the epoxy base resin in the resin formulation is replaced by a polysiloxane (1,3-bis(3-glycidyloxypropyl)tetramethyldisiloxane). The insulation material IM1 is produced from an impregnation formulation containing a resin formulation composed of 90% by weight of bisphenol A diglycidyl ether as epoxy base resin and 10% by weight of a cage-structured epoxycyclohexyl-substituted polysilsesquioxane (e.g. (epoxycyclohexyl)₈₋₁₂ (SiO_{1.5})₈₋₁₂). The hardener formulation used is likewise an approximately stoichiometric amount of methylhexahydrophthalic anhydride. The accelerator used in all three formulations IM, nIM1, nIM2 is the fundamentally optional accelerator benzyldimethylamine at 0.8% by weight based on the total mass of the respective impregnation formulation. Curing is effected in each case at 145° C. for about 10 h with subsequent storage in air at 50% relative air humidity at about 23° C. All insulation materials IM, nIM1, nIM2 were aged electrically at voltages of 10 kV for 100 h. Subsequently, the insulation materials IM, nIM1, nIM2 were scanned by a laser and hence the respective eroded volume Eᵥ and the respective erosion depth E_{T} were ascertained.

The electrical aging of the polymeric test specimens is effected in accordance with IEC 60343 (Recommended test methods for determining the relative resistance of insulating materials to break down by surface discharges). In what is called the Toepler arrangement, a rod electrode manufactured from stainless steel (diameter 6 mm/edge radius 1 mm) lies atop a test specimen (thickness 2 mm) under its own weight. If high voltage (here: 10 kV) is applied to the rod electrode over a defined period of time (here: 100 hours), at the triple point where the rod electrode separates from the test specimen, partial discharges are developed. These cause radially symmetric volume damage to the test specimen around the rod electrode, which is subsequently measured by laser triangulation, in order to ascertain the erosion depth E_{T} and the eroded volume Eᵥ. By means of these indices, it is possible to make a statement regarding the partial discharge resistance of the different test specimens.

It can be seen that the replacement of 10% by weight of the epoxy base resin content of a conventional Micalastic™ impregnation formulation with an epoxycyclohexyl-modified polysilsesquioxane (corresponding to 5% by weight in the solid insulation material IM) already offers the same or even a slightly improved erosion resistance compared to replacement with 10% by weight of a polysiloxane. At the same time, however, there is no decrease, but surprisingly actually an increase, in the glass transition temperature of the insulation material IM1 both compared to the noninventive polysiloxane-containing insulation material nIM1 and compared to the siloxane-free Micalastic™ insulation material nIM2.

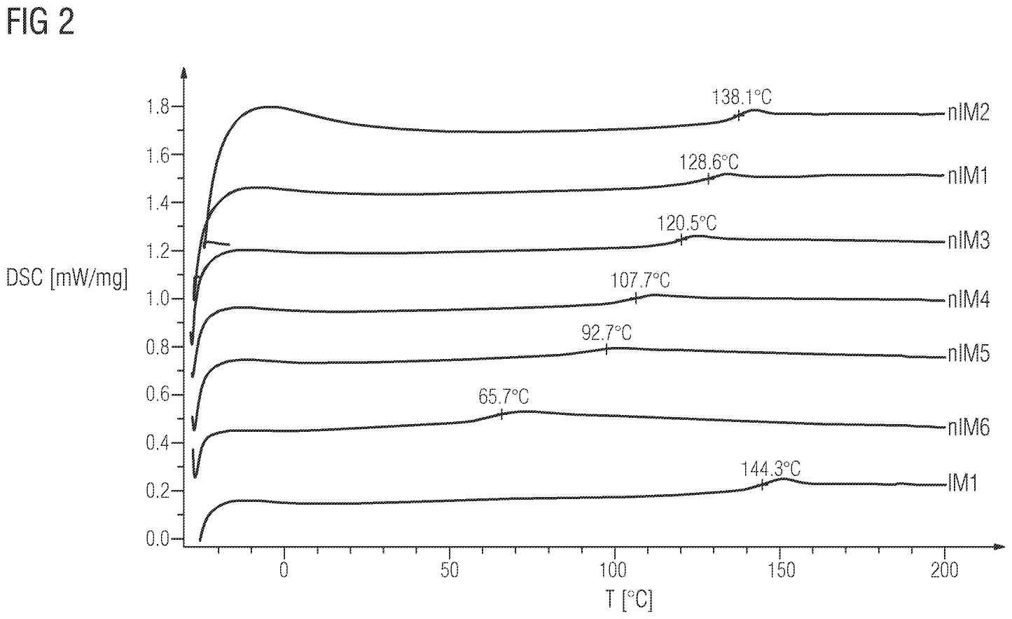

In this regard, FIG. 2 shows dynamic differential calorimetry measurements DSC [mW/mg] at 10 K/min on the insulation material IM1 compared to multiple insulation materials nIM1-nIM6. The compositions of the impregnation formulations from which the insulation materials IM, nIM1 and nIM2 were produced correspond to those from FIG. 1. The same applies to the curing parameters. In insulation materials nIM3-nIM6, compared to insulation material nIM1, 20% by weight (nIM3), 30% by weight (nIM4), 40% by weight (nIM5) and 60% by weight (nIM6) of the epoxy base resin of the resin formulation was exchanged for the polysiloxane mentioned. It can be seen from the temperature progressions T [° C.], that, with increasing polysiloxane content, there is a drop in the glass transition temperatures, each ascertained at the midpoint of the glass transition temperature ranges, from originally 138.1° C. (nIM2) to 65.7° C. (nIM6). By contrast, the use of the impregnation formulation incorporating teachings of the present disclosure with the polysilsesquioxane containing epoxycycloalkyl groups as a component of the resin formulation leads to an increase in the glass transition temperature of the insulation material IM1 to 144.3° C.

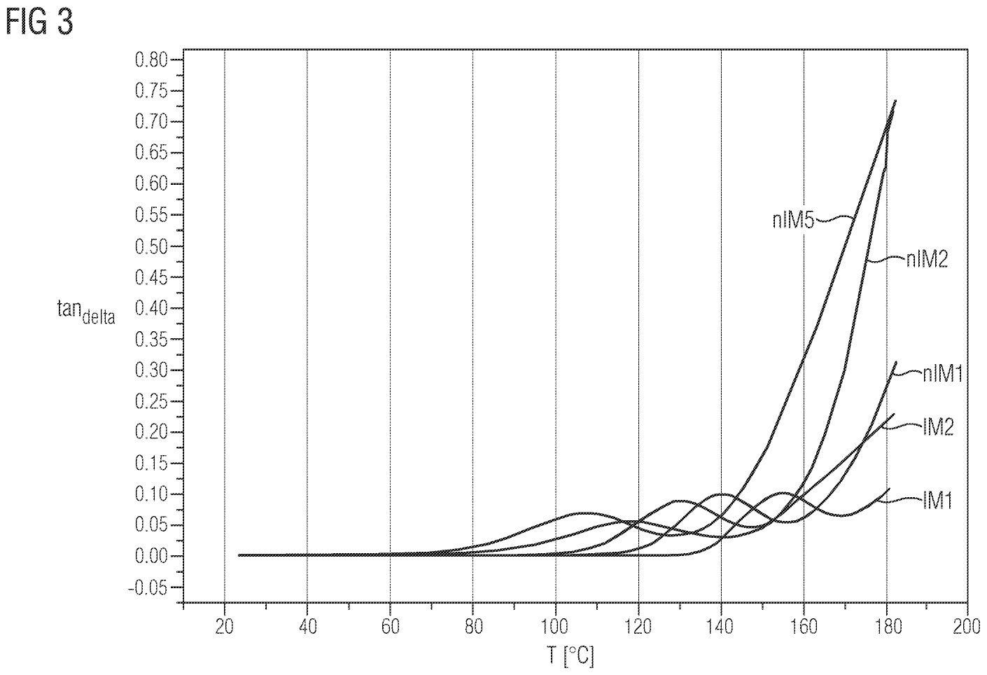

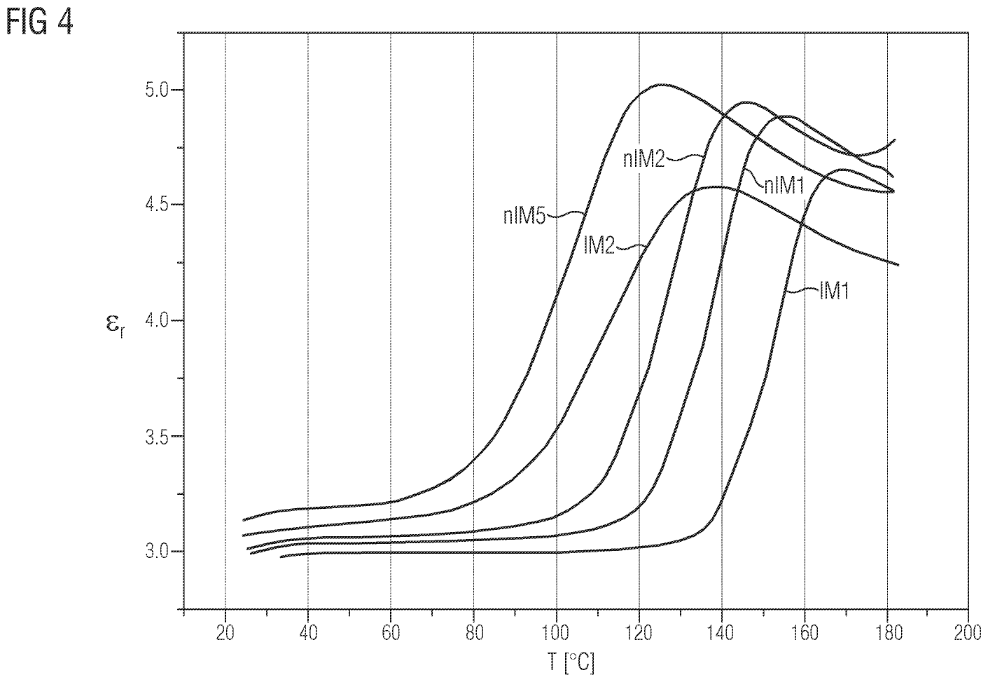

Astonishingly, and in a manner unpredictable to the person skilled in the art, dielectric indices such as electrical loss factor tan_{delta} (cf. FIG. 3) and relative permittivity Er (cf. FIG. 4) are improved in the impregnation formulation taught herein and in the insulation materials produced therefrom.

In this regard, FIG. 3 shows a diagram showing the electrical loss factors tan_{delta} of two working examples IM1, IM2 of the insulation material compared to the insulation materials nIM1, nIM2, nIM5 as a function of temperature T [° C.]. The insulation material IM2 is produced from an impregnation formulation in which the resin formulation is composed of 10% by weight of polysilsesquioxane ((epoxycyclohexyl)₈₋₁₂ (SiO_{1.5})₈₋₁₂), 40% by weight of polysiloxane (1,3-bis(3-glycidyloxypropyl)tetramethyldisiloxane) and 50% by weight of bisphenol A diglycidyl ether.

For all insulation materials IM1, IM2, nIM1, nIM2, nIM5 shown, the ratio of resin formulation to hardener formulation is 1:0.9 in terms of molar stoichiometry, and the individual impregnation formulations each contained benzyldimethylamine as accelerator and 0.8% by weight based on the total weight of the impregnation formulation. The electrical loss factors tan_{delta} are measured with the following parameters: 3 K/min on plaque specimens of thickness 2 mm, field strengths 500 V/mm, 50 Hz, contact pressure 250 g/m² to standard DIN 50483. A distinct improvement is apparent in the temperature progressions of the electrical loss factors tan_{delta} of the insulation materials IM1, IM2 compared to the insulation materials nIM1, nIM2, nIM5.

FIG. 4 shows a diagram showing the relative permittivities εᵣ of the insulation materials IM1, IM2 compared to the insulation materials nIM1, nIM2, nIM5. The relative permittivities εᵣ were measured according to standard DIN 50483 at 3 K/min on plaque specimens of thickness 2 mm, field strength 500 V/mm, 50 Hz and contact pressure 250 g/m².

Using tubular test specimens (not shown) that were fabricated for electrical characterization, by comparison with the reference Micalastic™ insulation system, significant improvements in the insulation materials IM were likewise found. In the case of 6-ply, semi-overlapping windings each of length 80 cm, at test voltage 19.6 kV/mm, an improvement in lifetime by a factor of 6 is found with a proportion of the epoxycycloalkyl group-containing component of at least 8.5% by weight in the resin formulation. It is possible by varying this proportion to adjust the improvement factor in view of the above-described change in the electrical loss factor tan_{delta} and the relative permittivity εᵣ to the respective end use.

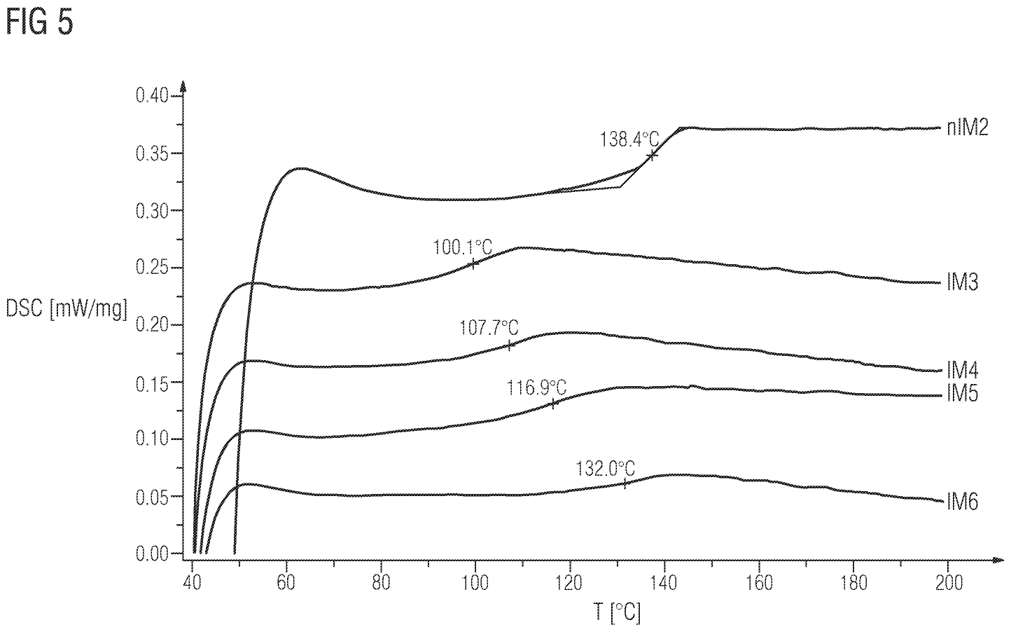

FIG. 5 shows dynamic differential calorimetry measurements DSC [mW/mg] at 10 K/min on different insulation materials IM3-IM6 compared to the insulation material nIM2. The insulation materials IM3-IM6 were produced from impregnation formulations that had the following mixtures as resin formulation:
IM3 40% by weight of polysiloxane-substituted epoxy resin component (1,3-bis(3-glycidyloxypropyl)tetramethyldisiloxane), 10% by weight of cycloaliphatic epoxy resin component (3,4-epoxycyclohexylmethyl 3′,4′-epoxycyclohexanecarboxylate), 50% by weight of bisphenol A diglycidyl ether as epoxy base resin;
IM4 40% by weight of polysiloxane-substituted epoxy resin component (1,3-bis(3-glycidyloxypropyl)tetramethyldisiloxane), 20% by weight of cycloaliphatic epoxy resin component (3,4-epoxycyclohexylmethyl 3′,4′-epoxycyclohexanecarboxylate), 40% by weight of bisphenol A diglycidyl ether as epoxy base resin;
IM5 40% by weight of polysiloxane-substituted epoxy resin component (1,3-bis(3-glycidyloxypropyl)tetramethyldisiloxane), 30% by weight of cycloaliphatic epoxy resin component (3,4-epoxycyclohexylmethyl 3′,4′-epoxycyclohexanecarboxylate), 30% by weight of bisphenol A diglycidyl ether as epoxy base resin; and
IM6 40% by weight of polysiloxane-substituted epoxy resin component (1,3-bis(3-glycidyloxypropyl)tetramethyldisiloxane), 40% by weight of cycloaliphatic epoxy resin component (3,4-epoxycyclohexylmethyl 3′,4′-epoxycyclohexanecarboxylate), 20% by weight of bisphenol A diglycidyl ether as epoxy base resin.

The hardener formulation used in all three cases IM3-IM6, likewise by way of example, was methylhexahydrophthalic anhydride. The accelerator used in all three impregnation formulations IM3-IM6 was the fundamentally optional accelerator benzyldimethylamine at 0.8% by weight, based on the total mass of the respective impregnation formulation.

It is apparent that, for example, impregnation formulation IM6 with the resin formulation of 40% by weight of polysiloxane, 40% by weight of cycloaliphatic epoxy resin component (3,4-epoxycyclohexylmethyl 3′,4′-epoxycyclohexanecarboxylate) and 20% by weight of bisphenol A glycidyl ether, and methylhexahydrophthalic anhydride as hardener formulation (1:0.9 in molar stoichiometric terms of resin formulation: hardener formulation), produces a similar glass transition after thermal hardening at 145° C. for 10 h to the completely polysiloxane-free Micalastic™ impregnation formulation nIM2.

In summary, impregnation formulations that may additionally contain polysiloxanes show distinctly increased electrical lifetimes compared to the prior art. The increase in erosion resistance is achieved by partial and/or additional replacement of the epoxy resin content by epoxycycloalkyl-modified compounds, especially by epoxycycloalkyl-modified polysilsesquioxanes. The described impregnation formulations are clear and mobile and can be processed in VPI processes, having identical gelation times to conventional impregnation formulations at standard processing temperatures, and forming more durable insulation materials after curing that have significantly higher electrical property indices and hence lifetimes. Organic-modified silsesquioxanes are commercially available and highly active even in comparatively small proportions, in order to achieve improved property indices. They also permit fundamentally optional blending with more favorable polysiloxanes.

Especially terminally modified polysilsesquioxanes are commercially available, and epoxycyclohexylethyl-functionalized polysilsesquioxanes in particular significantly increase the glass transition temperature and move the rises in electrical loss factor and relative permittivity significantly to higher temperatures. In addition, UV resistance, hydrophobicity, and partial discharge resistance are improved. All these properties permit the production of superior, highly durable and more compactly configurable electrical machines. Furthermore, the impregnation formulations described herein permit the use of higher field strengths, or give higher electrical lifetimes, particularly in generators and motors.

The parameter values reported in the documents for definition of processor measurement conditions for the characterization of specific properties are also considered to be encompassed by the scope of the disclosure within the scope of variances—for example on account of measurement errors, system errors, weighing errors, DIN tolerances and the like.

What is claimed is:

1. An impregnation formulation for a wrapping tape insulation of an electrical machine, the formulation comprising:
a resin formulation with an epoxy base resin and a first component; and
a hardener formulation with a hardener;
wherein the resin formulation reacts when combined with the hardener formulation to produce an insulation material;
the first component includes a saturated and/or unsaturated epoxycycloalkyl group; and
a glass transition temperature of the insulation material is elevated compared to an impregnation formulation without the first component.

2. The impregnation formulation as claimed in claim 1, wherein the first component comprises at least 2 saturated and/or unsaturated epoxycycloalkyl groups.

3. The impregnation formulation as claimed in claim 1, wherein the at least one epoxycycloalkyl group comprises a epoxy-C3-C8-cycloalkyl group. and/or wherein the at least one epoxycycloalkyl group is bonded to a structural element of the component via a spacer.

4. The impregnation formulation as claimed in claim 1, wherein the first component comprises a polysilsesquioxane containing epoxycycloalkyl groups.

5. The impregnation formulation as claimed in claim 4, wherein the polysilsesquioxane containing epoxycycloalkyl groups has a random structure, a ladder structure, or a cage structure.

6. The impregnation formulation as claimed in claim 1, wherein the first component includes: a cycloaliphatic epoxy resin.

7. The impregnation formulation as claimed in claim 1, wherein the resin formulation comprises a polysiloxane.

8. The impregnation formulation as claimed in claim 1, wherein the epoxy base resin is selected from the group consisting of: phthalic anhydride derivative-containing epoxy resins and phthalic anhydride derivative-free epoxy resins.

9. The impregnation formulation as claimed in claim 1, wherein the hardener formulation is selected from the group consisting of: cationic and anionic curing catalysts, amines, acid anhydrides, siloxane-based hardeners, oxirane group-containing hardeners, glycidyl ethers, superacids, epoxy-functionalized hardeners.

10. The impregnation formulation as claimed in claim 1, wherein the resin formulation includes compounds forming a —CR₂— backbone in a proportion of at least 10% by weight.

11. The impregnation formulation as claimed in claim 1, wherein a proportion of the first component in the resin formulation is at least 1% by weight and at most 95% by weight.

12. (canceled)

13. A method of producing an insulation material, the method comprising:
mixing a resin formulation with a hardener formulation;
wherein the resin formulation includes an epoxy base resin and a first component, and the hardener formulation includes a hardener;
wherein the resin formulation reacts when combined with the hardener formulation to produce an insulation material;
the first component includes a saturated and/or unsaturated epoxycycloalkyl group; and
curing the combined materials to form the insulation material with a glass transition temperature of at least 90° C., the glass transition temperature of the insulation material is elevated compare to an impregnation formulation without the first component.

14. The method as claimed in claim 13, wherein:
at least one element selected from the group of: support materials, barrier materials, and tape adhesives is impregnated with the impregnation formulation; and
the insulation material is produced by a vacuum pressure impregnation process.

15. (canceled)

16. The impregnation formulation as claimed in claim 1, wherein the at least one epoxycycloalkyl group is bonded to a structural element of the component via a spacer.

17. The impregnation formulation as claimed in claim 1, wherein the hardener formulation comprises an accelerator substance.

18. The impregnation formulation as claimed in claim 1, wherein the resin formulation includes compounds form a —SiR₂—O— backbone in a proportion of at least 5% by weight.
